(19) United States
(12) Patent Application Publication
(10) Pub. No.: US 2019/0353340 A1
(43) Pub. Date: Nov. 21, 2019

(54) Fire-Resistant Recessed Lighting Fixture

(71) Applicant: Eaton Intelligent Power Limited, Dublin (IE)

(72) Inventors: Russell Bryant Green, Douglasville, GA (US); Kevin Roy Harpenau, Atlanta, GA (US)

(21) Appl. No.: 16/054,922

(22) Filed: Aug. 3, 2018

Related U.S. Application Data
(60) Provisional application No. 62/674,362, filed on May 21, 2018.

(51) Int. Cl. F21V 25/12; F21S 8/02; F21V 15/01

(52) U.S. Cl. CPC F21V 25/125; F21V 15/01; F21S 8/026

(57) ABSTRACT

A fire-resistance rated lighting fixture includes intumescent coatings or materials. A recessed housing includes a body and a top with an intumescent material located in the top of the recessed housing. One or more brackets can hold the intumescent material in place within the top of the recessed housing. An intumescent coating can also be applied to one or more components of the fire-resistance rated lighting fixture.

### RELATED APPLICATIONS

The present application claims priority to U.S. Provisional Patent Application No. 62/674,362 filed May 21, 2018 and titled “Recessed Luminaire With Intumescent Coating,” the entire content of which is incorporated herein by reference.

### TECHNICAL FIELD

Embodiments of the invention relate generally to recessed lighting fixtures. Specifically, embodiments of the present disclosure relate to a fire-resistance rated recessed light fixture housing with intumescent materials or coatings.

### BACKGROUND

A recessed lighting fixture is a light fixture that is installed in a hollow opening in a ceiling. A typical installation of recessed lighting fixtures may include fastening hanger bars to spaced-apart ceiling supports or joists, and inserting a lamp housing or recessed housing can of the recessed lighting fixture into an aperture of a plaster frame that extends between the hanger bars. In particular, the recessed lighting fixture may be installed such that the bottom of the recessed lighting fixture is mounted flush with a visible surface of the ceiling, and the body of the recessed lighting fixture rests in a space above the ceiling. That is, the recessed lighting fixture may either be in contact with, or very close to, the ceiling, joists, or other flammable material above the ceiling, thus, requiring the recessed lighting fixtures to be fire-resistance rated for safety purposes.

Standards have been created that set forth the fire-resistance rating for the recessed lighting fixtures. For example, recessed lighting fixtures in multi-unit dwellings must be two hour fire-resistance rated, i.e., the recessed light fixtures must include a fire protection system that can withstand a standard fire resistant test for at least two hours. One way to achieve the required fire-resistance rating for a recessed light fixture is to build a double layer drywall box around the recessed light fixture. However, building the double layered drywall box adds cost and time to the lighting fixture installation. Another way to achieve the required fire-resistance rating is to place an outer housing box around and outside the recessed housing can of the recessed light fixture and fill the cavity between the outer housing box and the recessed housing can with fire resistant fibers. However, the heat resistant fibers reduce the thermal dissipation on the outside of the recessed housing can thereby raising a temperature of the recessed housing can and/or one or more other parts of the recessed lighting fixture beyond an acceptable level which is undesirable. Yet another way to achieve the required fire-resistance rating is to attach an intumescent material to the inside top wall of the outer housing box, but this would limit the heat dissipation from the top of the outer box thereby increasing a temperature of one or more parts of the recessed lighting fixture beyond an acceptable level which would be undesirable.

Accordingly, there is a need for a solution that satisfies the required fire-resistance rating for recessed lighting fixtures while providing proper heat dissipation to maintain the temperature of various parts of the recessed lighting fixtures within an acceptable level.

### SUMMARY

The present disclosure is directed to recessed lighting fixtures that comprise intumescent materials or coatings. In one example embodiment, the disclosure provides for a fire-resistance rated lighting fixture comprising a plaster frame, a recessed housing can positioned within an aperture in the plaster frame, an outer housing comprising at least one side wall and a top wall that form a cavity and surround the recessed housing can, and an intumescent material disposed in a space between the outer housing and the recessed housing can using one or more coupling members, the intumescent material disposed so that there is a gap between the intumescent material and the at least one side wall and a gap between the intumescent material and the top wall.

In another example embodiment, the disclosure provides a housing for a recessed component such a lighting fixture, receptacle or other device. The housing comprises a body with at least one side wall, a top attached to the at least one side wall, and an intumescent coating applied to the body and the top. The side wall comprises a side wall inner surface and a side wall outer surface. The top comprises a top inner surface and a top outer surface. The intumescent coating can be applied to one or more of the side wall inner surface, the side wall outer surface, the top inner surface and the top outer surface. The housing can also comprise a wiring aperture for receiving wiring to be connected to a light module or other device that can be disposed within the housing.

In yet another embodiment, the disclosure provides a housing for a recessed component such as a lighting fixture, receptacle, or other device. The housing comprises a body with at least one side wall, a top attached to the at least one side wall, and an intumescent material located within the housing. The side wall comprises a side wall inner surface and a side wall outer surface. The top comprises a top inner surface and a top outer surface. The intumescent material can be attached to a bracket and the bracket attached to at least one of the side wall inner surface and the top inner surface. In one example, the intumescent material can be located on a top surface of the bracket between the bracket and the top inner surface.

The foregoing examples and other aspects of the disclosure will be described in further detail in the following description with reference to the attached figures.

### BRIEF DESCRIPTION OF THE FIGURES

The foregoing and other features and aspects of the invention are best understood with reference to the following description of certain example embodiments, when read in conjunction with the accompanying drawings, wherein:

FIG. 1A illustrates a perspective view of an example fire-resistance rated recessed lighting fixture, in accordance with example embodiments of the present disclosure;

FIG. 1B illustrates another perspective view of the fire-resistance rated recessed lighting fixture of FIG. 1A with the outer housing made transparent to illustrate the internal components of the fire-resistance rated recessed lighting fixture, in accordance with example embodiments of the present disclosure;

FIG. 1C illustrates yet another perspective view of the fire-resistance rated recessed lighting fixture of FIG. 1A with the outer housing made transparent to illustrate the internal components of the fire-resistance rated recessed lighting fixture, in accordance with example embodiments of the present disclosure;

FIG. 1D illustrates a top view of the fire-resistance rated recessed lighting fixture of FIG. 1A with the outer housing made transparent to illustrate the internal components of the fire-resistance rated recessed lighting fixture, in accordance with example embodiments of the present disclosure;

FIG. 1E illustrates a side view of one side of the fire-resistance rated recessed lighting fixture of FIG. 1A with the outer housing made transparent to illustrate the internal components of the fire-resistance rated recessed lighting fixture, in accordance with example embodiments of the present disclosure;

FIG. 1F illustrates a side view of another side of the fire-resistance rated recessed lighting fixture of FIG. 1A with the outer housing made transparent to illustrate the internal components of the fire-resistance rated recessed lighting fixture, in accordance with example embodiments of the present disclosure;

FIG. 1G illustrates a cross-sectional view of the fire-resistance rated recessed lighting fixture of FIG. 1A along the Y-Y′ axis shown in FIG. 1D, in accordance with example embodiments of the present disclosure;

FIG. 2A illustrates a perspective view of another example fire-resistance rated recessed lighting fixture with the outer housing made transparent to illustrate the internal components of the fire-resistance rated recessed lighting fixture, in accordance with example embodiments of the present disclosure;

FIG. 2B illustrates a cross-sectional view of the fire-resistance rated recessed lighting fixture of FIG. 2A, in accordance with example embodiments of the present disclosure;

FIG. 2C illustrates a side view of one side of the fire-resistance rated recessed lighting fixture of FIG. 2A with the outer housing made transparent to illustrate the internal components of the fire-resistance rated recessed lighting fixture, in accordance with example embodiments of the present disclosure;

FIG. 2D illustrates a side view of another side of the fire-resistance rated recessed lighting fixture of FIG. 1A with the outer housing made transparent to illustrate the internal components of the fire-resistance rated recessed lighting fixture, in accordance with example embodiments of the present disclosure;

FIG. 3A illustrates a perspective view of the plaster frame of the fire-resistance rated recessed lighting fixture, in accordance with example embodiments of the present disclosure;

FIG. 3B illustrates another perspective view of the plaster frame of the fire-resistance rated recessed lighting fixture, in accordance with example embodiments of the present disclosure;

FIG. 4 illustrates the outer housing of the fire-resistance rated recessed lighting fixture, in accordance with example embodiments of the present disclosure;

FIG. 5 illustrates a top perspective view of an example fire-resistance rated recessed lighting fixture, in accordance with example embodiments of the present disclosure;

FIG. 6 illustrates a bottom perspective view of the fire-resistance rated recessed lighting fixture of FIG. 5, in accordance with example embodiments of the present disclosure;

FIG. 7 illustrates a top perspective view of another example fire-resistance rated recessed lighting fixture, in accordance with example embodiments of the present disclosure;

FIG. 8 illustrates a bottom perspective view of the fire-resistance rated recessed lighting fixture of FIG. 7, in accordance with example embodiments of the present disclosure;

FIG. 9 illustrates a top perspective view of an example fire-resistance rated recessed lighting fixture, in accordance with example embodiments of the present disclosure;

FIG. 10 illustrates a cross-sectional view of the fire-resistance rated recessed lighting fixture of FIG. 9, in accordance with example embodiments of the present disclosure; and

FIG. 11 illustrates an exploded view of a portion of the fire-resistance rated recessed lighting fixture of FIG. 9, in accordance with example embodiments of the present disclosure.

The drawings illustrate only example embodiments of the disclosure and are therefore not to be considered limiting of its scope, as the disclosure may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles.

### DETAILED DESCRIPTION OF EXAMPLE EMBODIMENTS

The present disclosure describes a fire-resistance rated recessed lighting fixture (herein “lighting fixture”) that includes an outer metal housing box (herein “outer housing”) disposed around and over a recessed housing can (herein “can”). Further, the lighting fixture includes an intumescent material that is disposed above the can in a space between the top of the can and the top of the outer housing using one or more coupling brackets and fasteners such that the intumescent material is not in direct contact with any surface of the outer box. That is, the intumescent material is suspended in the space between the can and the outer box such that it does not touch any surface of the outer box, thereby not restricting heat dissipation from the can and the outer box while maintaining the fire-resistance rating standards.

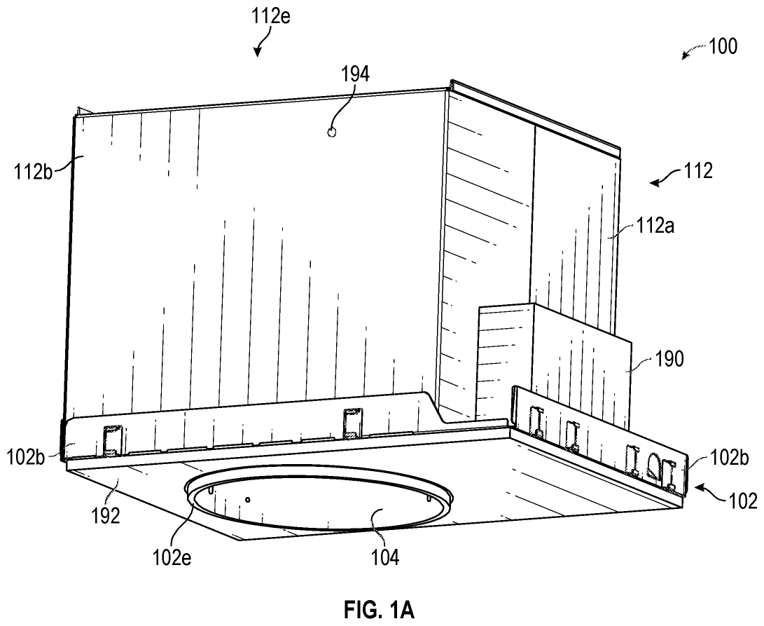

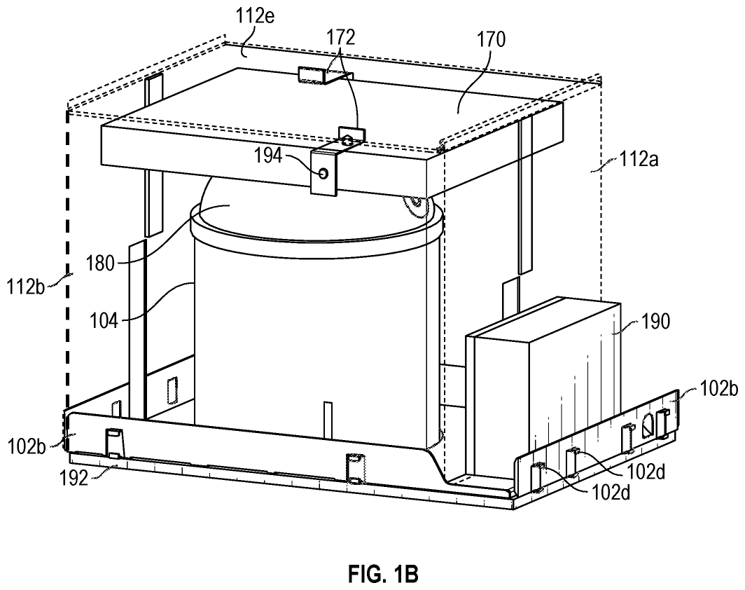

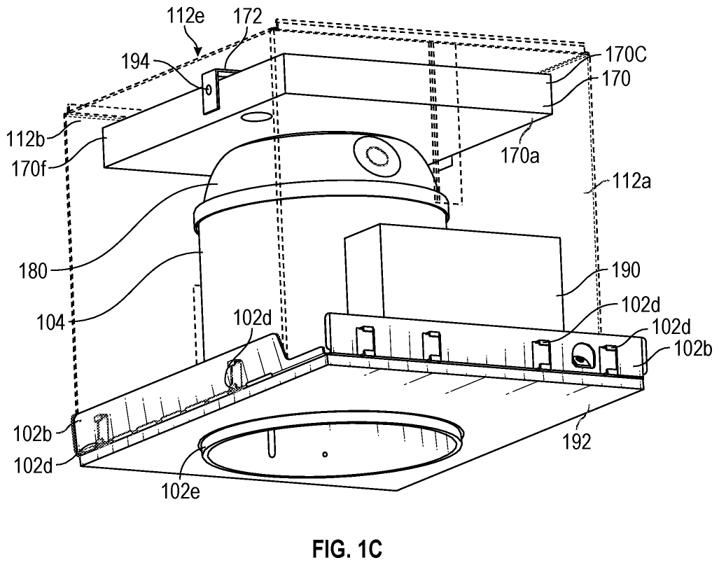

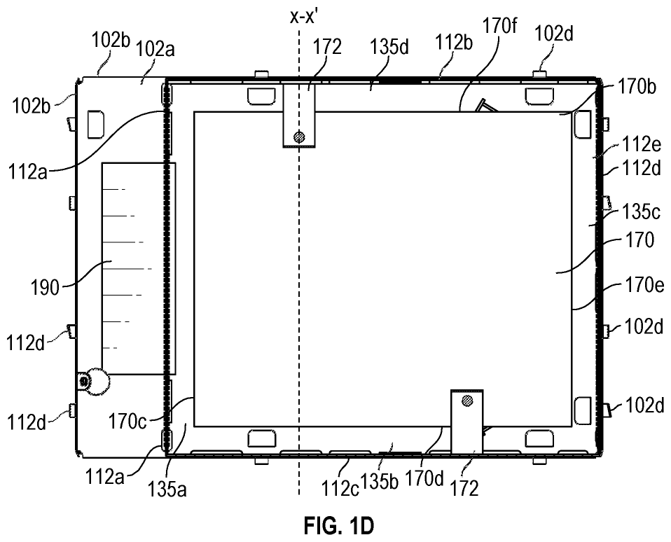

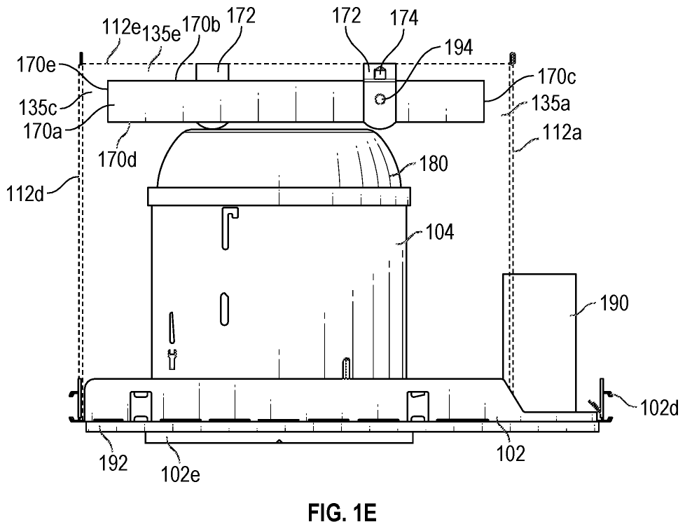

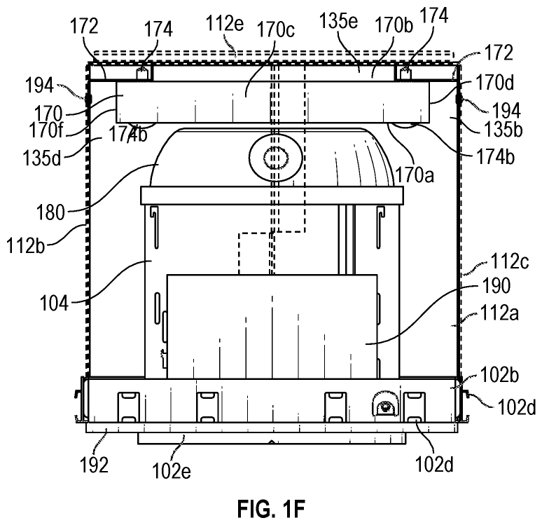

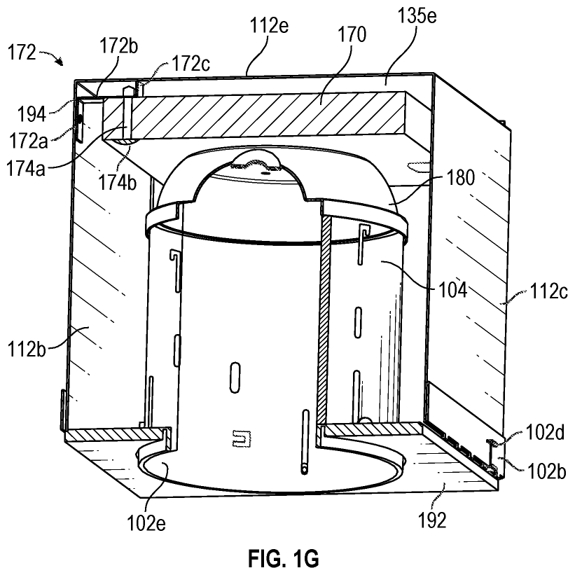

FIG. 1A illustrates a perspective view of an example fire-resistance rated recessed lighting fixture, in accordance with example embodiments of the present disclosure; FIG. 1B illustrates another perspective view of the fire-resistance rated recessed lighting fixture of FIG. 1A with the outer housing made transparent to illustrate the internal components of the fire-resistance rated recessed lighting fixture, in accordance with example embodiments of the present disclosure; FIG. 1C illustrates yet another perspective view of the fire-resistance rated recessed lighting fixture of FIG. 1A with the outer housing made transparent to illustrate the internal components of the fire-resistance rated recessed lighting fixture, in accordance with example embodiments of the present disclosure; FIG. 1D illustrates a top view of the fire-resistance rated recessed lighting fixture of FIG. 1A with the outer housing made transparent to illustrate the internal components of the fire-resistance rated recessed lighting fixture, in accordance with example embodiments of the present disclosure; FIG. 1E illustrates a side view of the fire-resistance rated recessed lighting fixture of FIG. 1A with the outer housing made transparent to illustrate the internal components of the fire-resistance rated recessed lighting fixture, in accordance with example embodiments of the present disclosure; FIG. 1F illustrates a front view of the fire-resistance rated recessed lighting fixture of FIG. 1A with the outer housing made transparent to illustrate the internal components of the fire-resistance rated recessed lighting fixture, in accordance with example embodiments of the present disclosure; and FIG. 1G illustrates a cross-sectional view of the fire-resistance rated recessed lighting fixture of FIG. 1A along the Y-Y′ axis shown in FIG. 1D, in accordance with example embodiments of the present disclosure. Hereinafter, FIGS. 1A-1G may be collectively and interchangeably referred to as FIG. 1.

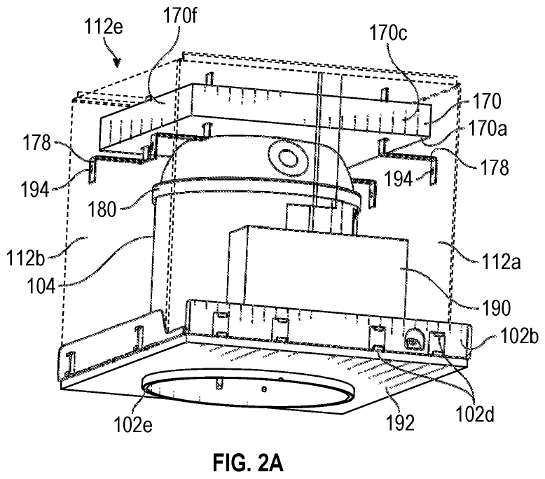

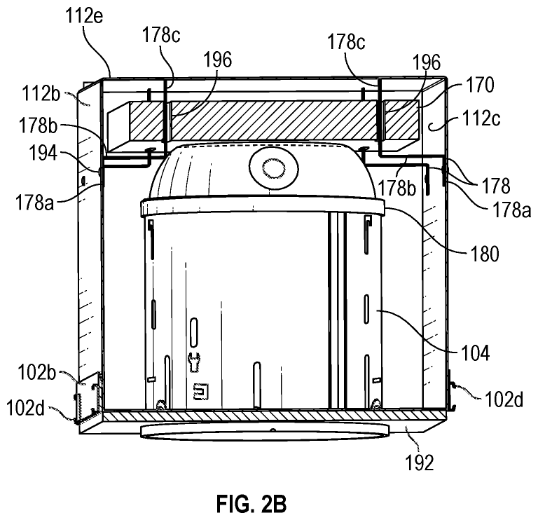

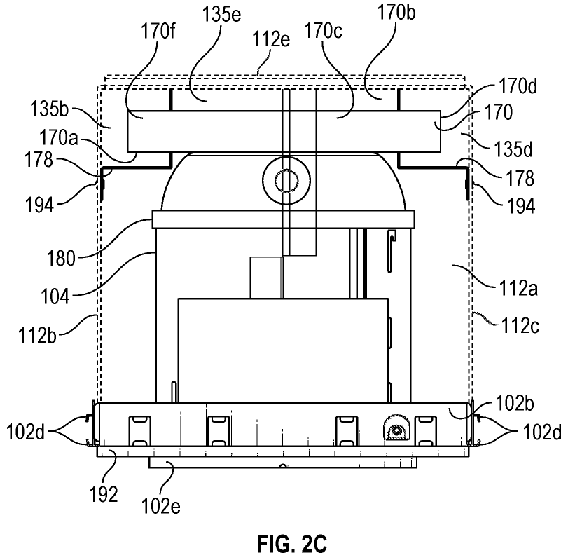

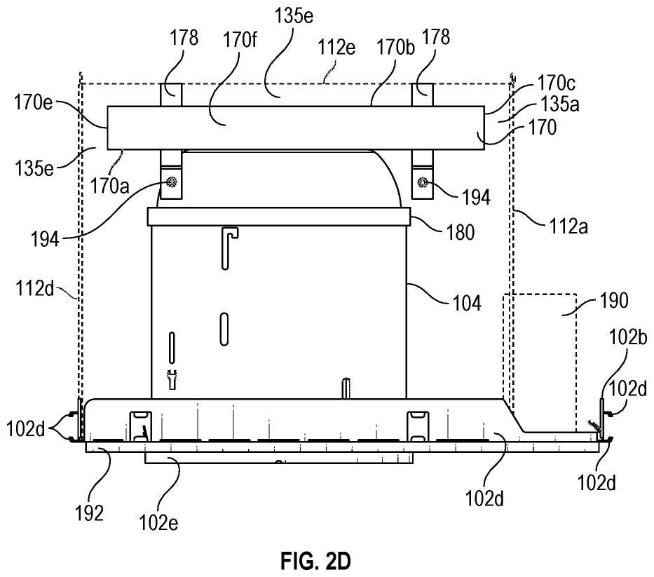

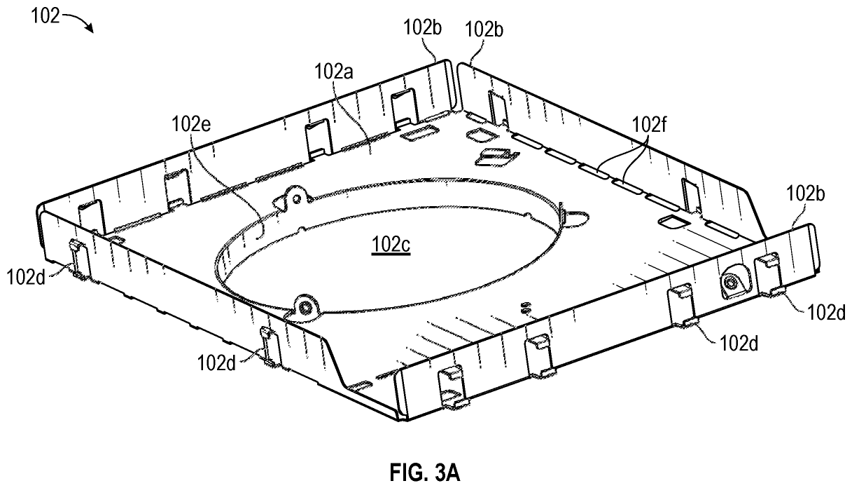

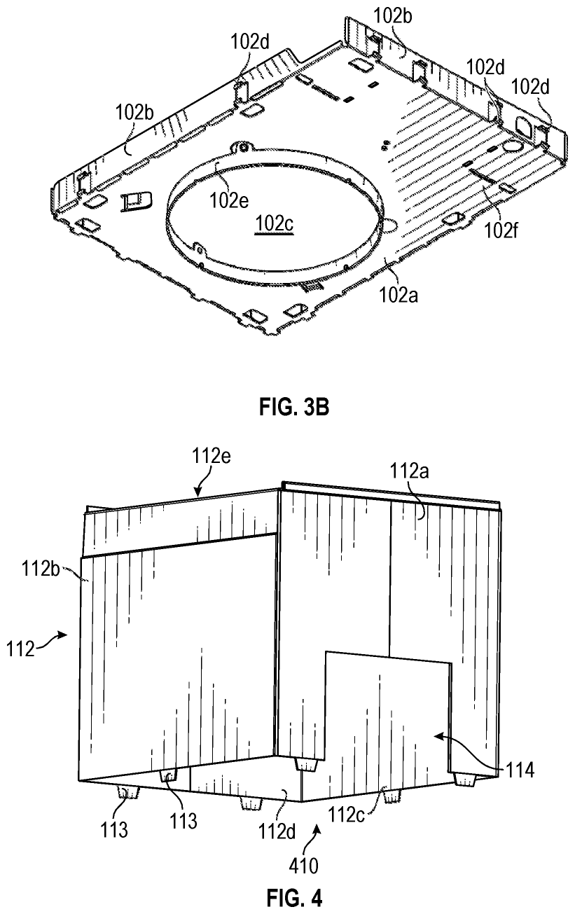

Further, FIG. 2A illustrates a perspective view of another example fire-resistance rated recessed lighting fixture with the outer housing made transparent to illustrate the internal components of the fire-resistance rated recessed lighting fixture, in accordance with example embodiments of the present disclosure; FIG. 2B illustrates a cross-sectional view of the fire-resistance rated recessed lighting fixture of FIG. 2A, in accordance with example embodiments of the present disclosure; FIG. 2C illustrates a front view of the fire-resistance rated recessed lighting fixture of FIG. 2A with the outer housing made transparent to illustrate the internal components of the fire-resistance rated recessed lighting fixture, in accordance with example embodiments of the present disclosure; FIG. 2D illustrates a side view of the fire-resistance rated recessed lighting fixture of FIG. 1A with the outer housing made transparent to illustrate the internal components of the fire-resistance rated recessed lighting fixture, in accordance with example embodiments of the present disclosure; FIG. 3A illustrates a perspective view of the plaster frame of the fire-resistance rated recessed lighting fixture, in accordance with example embodiments of the present disclosure; FIG. 3B illustrates another perspective view of the plaster frame of the fire-resistance rated recessed lighting fixture, in accordance with example embodiments of the present disclosure; and FIG. 4 illustrates the outer housing of the fire-resistance rated recessed lighting fixture, in accordance with example embodiments of the present disclosure.

Referring to FIGS. 1-4, the example lighting fixture 100 may include, inter alia, an outer housing 112, a can 104 (also referred to herein as a “recessed housing” or “housing”), a junction box 190, a plaster frame 102, an intumescent material 170, and brackets 172/178 to suspend the intumescent material 170. In certain example embodiments, as illustrated in FIG. 4, the outer housing 112 may include four vertical walls 112a, 112b, 112c, and 112d (herein ‘side walls’) and a top wall 112e that are arranged such that they define a cavity 410. In particular, each of the four side walls 112a, 112b, 112c, and 112d may be coupled along its respective top edge to an edge of the top wall 112e such that each side wall (112a-d) is substantially perpendicular to the top wall 112e. Further, the side walls 112a and 112d are parallel to one another and the side walls 112b and 112c are parallel to one another. In another example embodiment, the four side walls 112a, 112b, 112c, and 112d, and the top wall 112e may be an integral housing stamped or formed from a single piece of material. In certain example embodiments, the outer housing 112 may be made from a metallic material, e.g., aluminum; however, in other alternative embodiments the outer housing 112 may be formed using any other appropriate material without departing from a broader scope of the present disclosure. Furthermore, in other example embodiments, the outer housing 112 may have any other shape other than the shape illustrated in FIG. 4. For example, the outer housing 112 may be cylindrical comprising a cylindrical shaped side wall and a top wall.

In certain example embodiments, as illustrated in FIG. 4, one of the side walls 112a may include an aperture 114 that is generally shaped to substantially match the shape of a junction box 190. In particular, the side wall 112a may be positioned adjacent to the junction box 190 such that the junction box 190 abuts against the aperture 114 and limits heat dissipation through the aperture 114.

As referred to herein, the junction box 190 may be a box having insulated wiring terminals and/or knock-outs configured to house electrical components associated with and/or connecting external wiring (not shown) to a lamp assembly (not shown) of the lighting fixture 100. In certain example embodiments, the junction box 190 may include pre-installed wiring from the lamp assembly (not shown) with or without electrical wire connectors for easy connection to external wiring (e.g., building wiring), provided the fire-resistance rated recessed lighting fixture comes pre-assembled.

Even though the present disclosure describes the outer housing 112 as having an aperture 114 and a junction box 190 positioned adjacent to the junction box 190 such that the junction box 190 abuts against the aperture 114, one of ordinary skill in the art can understand and appreciate that in other embodiments, the outer housing 112 may not include the aperture 114 and the junction box 190 may be positioned (on the plaster frame 102) away from the outer housing 112. Further, the lamp assembly described herein may include any appropriate light source or light source assembly such as, but not limited to, halogen lamps, light emitting diode (LED) based light source modules, light bulbs, etc., without departing from a broader scope of the present disclosure.

As illustrated in FIGS. 1-2, the outer housing 112 and/or the junction box 190 may be disposed on the plaster frame 102. In particular, the outer housing 112 may be releasably coupled to the plaster frame 102 by placing the tabs 113 (shown in FIG. 4) positioned along the bottom side of the outer housing 112 through the slots 102f (shown in FIG. 3B) in the plaster frame 102. Similarly, the junction box 190 that is positioned adjacent the outer housing 112 may be disposed on and releasably coupled to the plaster frame 102. Even though the present disclosure describes the outer housing 112 and the junction box 190 as being releasably coupled to the plaster frame 102 using tabs inserted into slots of the plaster frame, one of ordinary skill in the art can understand and appreciate that in some embodiments, the outer housing 112 and/or the junction box 190 may be integral to or fixed to the plaster frame 102 or may be releasably coupled using any other coupling mechanism without departing from a broader scope of the present disclosure.

As illustrated in FIGS. 3A and 3B, the plaster frame 102 may include a generally flat plate 102 a with upturned flanges 102 b. The flat plate 102a of the plaster frame 102 may include a plurality of apertures 102 f that are configured to receive tabs 113 (or other coupling mechanisms) of components (e.g., outer housing 112, junction box 190, etc.) for coupling said components to the plaster frame 102. Further, the flat plate 102 a of the plaster frame 102 may include a generally circular aperture 102c sized for receiving a can 104.

The can 104 may generally have a cylindrical shape at the bottom portion and may include a first aperture positioned along the bottom edge of the can 104, while the top portion 180 is generally dome shaped. The dome shaped top portion 180 may include an aperture that is configured to receive electrical wires for providing power supply to a lamp assembly (not shown) disposed (removably) within the can 104. The can 104 may be slidably engaged to the plaster frame 102 through the circular aperture 102c by positioning at least a portion of the can 104 through the circular aperture 102c such that the bottom edge of the can 104 is flush with a visible surface of the ceiling, and a remaining body of the can 104 rests within the cavity 410 of the outer housing 112. Even though the present disclosure describes the can as having a cylindrical bottom portion and a dome-shaped top portion, one of ordinary skill in the art can understand and appreciate that in some embodiments, the can may have any other appropriate geometric or non-geometric shape without departing from a broader scope of the present disclosure. For example, in some embodiments, the can 104 may not include the dome-shaped top portion 180. Instead, the can 104 may have an open top, i.e., a cylindrical body with a circular aperture at the top edge and the bottom edge of the can 104. Further, even though the present disclosure describes the aperture 102c as being generally circular corresponding to a profile of the can, a person of ordinary skill in the art having the benefit of the present disclosure will recognize that, in certain alternative example embodiments, the aperture 102c can have a different, non-circular shape that corresponds to an outer profile of the can 104.

The aperture 102c of the plaster frame 102 may provide an illumination pathway for a light source of a lamp assembly (not shown) that may be placed within the can 104 using torsion springs, friction clips, or other coupling mechanisms. Further, the plaster frame 102 may include a downward facing flange 102e extending along a perimeter of the circular aperture 102c. However, a person of ordinary skill in the art can understand and appreciate that in some embodiments, the plaster frame 102 may not include the flange 102e around the perimeter of the aperture 102c.

With continued reference to FIGS. 3A and 3B, the flat plate 102 a of the plaster frame 102 may be configured to rest on a top surface of a ceiling in between joists of the ceiling or be positioned adjacent to and substantially parallel with the top surface of the ceiling using a pair of hangar bars (not shown). The hangar bars may be fastened to the joists and the plaster frame 102 may be attached to the hangar bars using the one or more tabs 102d on the upturned flanges 102b of the plaster frame 102 such that the plaster frame 102 is positioned between the joists of the ceiling. A detailed description of the hangar bars and how the hangar bars are attached to the joists is disclosed in U.S. Pat. No. 7,824,080, titled “Housing for a Recessed Light Fixture”, U.S. patent application Ser. No. 10/090,654, titled “Hanger Bar for Recessed Luminaires with Integral Nail,” and U.S. Pat. No. 6,105,918, titled “Single Piece Adjustable Hanger Bar for Lighting Fixtures,” the complete disclosure of each of which is hereby fully incorporated herein by reference.

Even though the present disclosure describes the plaster frame as having a specific shape as described herein, one of ordinary skill in the art can understand and appreciate that in other example embodiments, the plaster frame 102 can take the form of several other shapes including, but not limited to the shapes of a parallelogram, square, rectangle or other shapes known to those of ordinary skill in the art. Further, in certain example embodiments, the plaster frame 102 is typically made of a metallic material, for example steel, or any other appropriate material that is capable to wick thermal energy from the can 104 and the lamp assembly (not shown).

In addition to the plaster frame 102, the outer housing 112, the junction box 190, and the can 104, the example lighting fixture 100 may further include a housing gasket 192 that is attached to the bottom side of the plaster frame 102 to provide air tightness and prevent any light loss from the lighting fixture 100. In particular, the housing gasket 192 may be shaped substantially similar to the profile of the bottom surface of the plaster frame 102 including the aperture 102c such that the gasket 192 snuggly fits the bottom surface of the plaster frame 102. That is, similar to the flat plate 102 a of the plaster frame 102, the gasket 192 may include an aperture that aligns with the aperture 102c of the plaster frame 102.

Referring back to FIGS. 1-2, the example lighting fixture 100 may also include an intumescent material 170. The term ‘intumescent’ as used herein may generally refer to a substance that swells as a result of heat exposure, thus increasing in volume and decreasing in density. The intumescent material 170 as illustrated in FIGS. 1-2 may be shaped as a cuboid, i.e., with a substantially rectangular cross-section. In particular, the intumescent material 170 may include a bottom surface 170a, a top surface 170b opposite to the bottom surface 170a, and four side edges 170c-f extending from the bottom surface 170a to the top surface 170b. However, one of ordinary skill in the art can understand and appreciate that the intumescent material 170 can have any other appropriate shape without departing from a broader scope of the present disclosure. Further, one of ordinary skill in the art can understand and appreciate that in other example embodiments the intumescent material 170 can be replaced by any other appropriate material having substantially similar properties and can actively or passively contain the spreading of fire.

As illustrated in FIGS. 1-2, the intumescent material 170 may be disposed within the cavity 410 of the outer housing 112, particularly in a space between the top wall 112e of the outer housing and a top of the can 104 using one or more brackets 172 or 178 such that the intumescent material 170 is detached from, i.e., does not directly touch or is not in direct contact with any of the walls of the outer housing 112, e.g., the side walls 112a-d and top wall 112e. However, one of ordinary skill in the art can understand and appreciate that the intumescent material 170 may be positioned at any other space between the outer housing 112 and the can 104 without departing from a broader scope of the present disclosure. Further, as illustrated in FIGS. 1 and 2, the perimeter/circumference of the intumescent material 170 may be smaller than the perimeter/circumference of the outer housing 112 allowing the intumescent material 170 to be detached from, i.e., does not directly touch or is not in direct contact with any of the walls of the outer housing 112.

In particular, as illustrated in FIGS. 1-2, one or more brackets 172 or 178 may be attached to the side walls (112a, 112b, 112c, and/or 112d) of the outer housing 112 and the intumescent material 170 may in turn be attached to the brackets 172 or 178 such that the intumescent material 170 is detached from the outer housing 112. For example, in FIG. 1, the intumescent material 170 may be disposed within the lighting fixture 100 using one or more Z-shaped brackets 172 and corresponding Christmas tree pins/screws 174. In particular, each Z-shaped bracket 172 may include a first long leg 172 a, a second leg 172b that is substantially perpendicular to the first long leg 172 a and extending from a first end of the first long leg 172a, and a third short leg 172c that is substantially perpendicular to the second leg 172b and extending from an end of the second leg 172b that is away from the first long leg 172a. Further, the first long leg 172a and the third short leg 172c may be substantially parallel to each other and may extend in opposite directions. As illustrated in FIGS. 1B, 1C, and 1E-1G, the first long leg 172a of each Z-shaped bracket 172 may be attached to a side wall of the outer housing 112 using rivets 194 such that the third short leg 172c of the Z-shaped bracket 172 extends away from the respective side wall to an opposite side wall of the outer housing 112. Similarly, one or more Z-shaped brackets 172 may be attached to one or more side walls of the outer housing 112 as illustrated in FIG. 1.

Once the Z-shaped brackets 172 are attached to one or more side walls of the outer housing 112, as illustrated in FIG. 1, the intumescent material 170 may be attached to each Z-shaped brackets 172 using a corresponding Christmas tree pin/screw 174. For example, the second leg 172b of the Z-shaped bracket 172 may have an aperture (not show) that is configured to receive the stem portion 174a of Christmas tree pin/screw 174 such that the intumescent material 170 is securely disposed between a head portion 174b of the Christmas tree pin/screw 174 and the second leg 172b of the Z-shaped bracket 172. In particular, the stem portion 174a of each Christmas tree pin/screw 174 may enter the bottom surface 170a of the intumescent material 170, pass through the intumescent material 170, exit through the top surface 170b of the intumescent material 170, and engage the aperture on the second leg 172b of the respective Z-shaped bracket 172 to securely dispose the intumescent material 170 within the lighting fixture 100 (between the Christmas tree pin head 174b and the second leg 172b of the bracket 172) such that the intumescent material 170 is detached from the outer housing 112.

In another example embodiment, as illustrated in FIG. 2, the intumescent material 170 may be disposed within the lighting fixture 100 using one or more Z-shaped brackets 178. In particular, each Z-shaped bracket 178 may include a first short leg 178a, a second leg 178b that is substantially perpendicular to the first short leg 178a and extending from a first end of the first short leg 178a, and a third long leg 178c that is substantially perpendicular to the second leg 178b and extending from an end of the second leg 178b that is away from the first short leg 178a. Further, the first short leg 178a and the third long leg 178c may be substantially parallel to each other and may extend in opposite directions. As illustrated in FIG. 2, the first short leg 178a of each Z-shaped bracket 178 may be attached to a side wall of the outer housing 112 using rivets 194 such that the third long leg 178c of the Z-shaped bracket 178 extends away from the respective side wall to an opposite side wall of the outer housing 112. Similarly, one or more Z-shaped brackets 178 may be attached to one or more side walls of the outer housing 112 as illustrated in FIG. 2.

Once the Z-shaped brackets 178 are attached to one or more side walls of the outer housing 112, as illustrated in FIG. 2, one or more incisions 196 may be made in the intumescent material 170 such that the incisions 196 align with the position of the third long leg 178c of each Z-shaped bracket 178. Further, the intumescent material 170 may be placed on top of the third long leg 178c of the one or more Z-shaped brackets 178, and the intumescent material 170 is slidingly pushed down towards the second leg 178b of the one or more Z-shaped brackets 178 to securely retain the intumescent material 170 within the lighting fixture 100. In some example embodiments, incisions 196 may not be made initially. Instead, the intumescent material 170 may be pushed down along the third long leg 178c of each Z-shaped bracket 178 which in turn creates the incisions through the applied pressure.

In certain example embodiments, the intumescent material 170 may also be detached from the can 104, i.e., does not touch or is not in direct contact with the top portion (top of dome portion 180) of the can 104. However, in other example embodiments, the intumescent material 170 may touch or be in direct contact with the can 104.

In particular, as illustrated in FIGS. 1D-1G and FIGS. 2C-2D, the intumescent material 170 may be disposed in the space between the top wall 112e of the outer housing and the dome portion 180 of the can 104 such that: (i) a space/gap (e.g., air gap) 135 a-d exists between the side walls 112a-d of the outer housing 112 and the side edges 170c-f of the intumescent material 170, respectively; and (ii) a space/gap 135e exists between the top wall 112e of the outer housing 112 and the top surface 170b of the intumescent material 170, thereby providing room for heat dissipation to the outer housing 112. In certain example embodiments, the space/gap 135a-e may range from ⅛ inch to 1 inch. However, one of ordinary skill in the art can understand and appreciate that in some embodiments the space/gap 135a-e may be smaller or larger than the above-mentioned range without departing from a broader scope of the present disclosure.

Even though the present description describes the brackets as being attached to the side walls of the outer housing 112, one of ordinary skill in the art can understand and appreciate that the brackets can be attached at any other portion on the outer housing that allows the intumescent material 170 to be disposed without being in direct contact with any of the walls of the outer housing 102. Further, even though the present disclosure describes one or more specific coupling mechanisms for disposing the intumescent material 170 within the fire-resistance rated recessed lighting fixture using brackets, one of ordinary skill in the art can understand and appreciate that any other coupling mechanism that disposes the intumescent material 170 in the lighting fixture such that the intumescent material 170 does not touch or is not in direct contact with any of the walls of the outer housing and/or the can may be used without departing from a broader scope of the present disclosure. For example, the intumescent material may be disposed within the lighting fixture using one or more suspension wires. Further, more than one intumescent material may be disposed in the lighting fixture 100 using the coupling members (e.g., brackets) without departing from a broader scope of the present disclosure.

The arrangement of the intumescent material 170 within the lighting fixture 100 as described herein satisfies the fire-resistance rating standard while providing proper heat dissipation to maintain the temperature of various parts of the recessed lighting fixtures within an acceptable level. For example, when there is no fire and the lighting fixture 100 is operational, the heat dissipation from the can 104 and the outer housing 112 is not obstructed by the intumescent material 170 because the intumescent material 170 is disposed such that it does not touch any surface of the outer housing 112 and/or the can 104. However, when there is a fire and the fire enters the outer housing 112, the intumescent material 170 may form a “char” material, which has a relatively low thermal conductivity. This char may expand filling any voids in the lighting fixture 100 and any voids created by the lighting fixture 100 in the ceiling. The char forms an effective thermal and flame barrier and substantially prevents flames or smoke from passing through into the space above the ceiling. In one example embodiment, the intumescent material 170 may substantially fill the entire space between the outer housing 112 and the can 104 or the entire cavity 410 of the outer housing 112. The char may also potentially move the can 104 through the aperture 102c. The intumescent material 170 in the example embodiment of the present disclosure is designed so that it will not “activate” during the normal running of the lighting fixture 100 and will only activate at a higher temperature generated by a fire.

Further, disposing the intumescent material 170 as described above using brackets and/or pins may allow easy replacement of the intumescent material 170 as compared to conventional techniques of attaching/sticking the intumescent material 170 to the walls of the outer housing 112.

In another embodiment, the present disclosure describes a recessed lighting fixture that includes an intumescent coating to provide fire-resistance. Consistent with the previous usage of intumescent material, the intumescent coating generally refers to a substance that swells as a result of heat exposure, thus increasing in volume and decreasing in density. The intumescent coating can be applied to the recessed lighting fixture as a liquid using a sprayer or other applicator in a manner similar to applying paint. Some non-limiting examples of intumescent coatings that can be applied to recessed lighting fixtures include Firetex FX5120 water based intumescent coating from Sherwin Williams, Firetex FX5090 water based intumescent coating from Sherwin Williams, and thermal insulating intumescent epoxy paint having flame control number 46081 from Flame Control Coatings, LLC. Applying an intumescent coating to the recessed lighting fixture provides several advantages. For example, unlike a box or other intumescent materials placed around the recessed lighting fixture, the intumescent coating permits air to flow more easily around the recessed lighting fixture thereby facilitating heat dissipation. Another advantage when compared to prior art approaches is that the intumescent coating reduces the required materials and simplifies the installation of the recessed lighting fixture, thereby reducing cost.

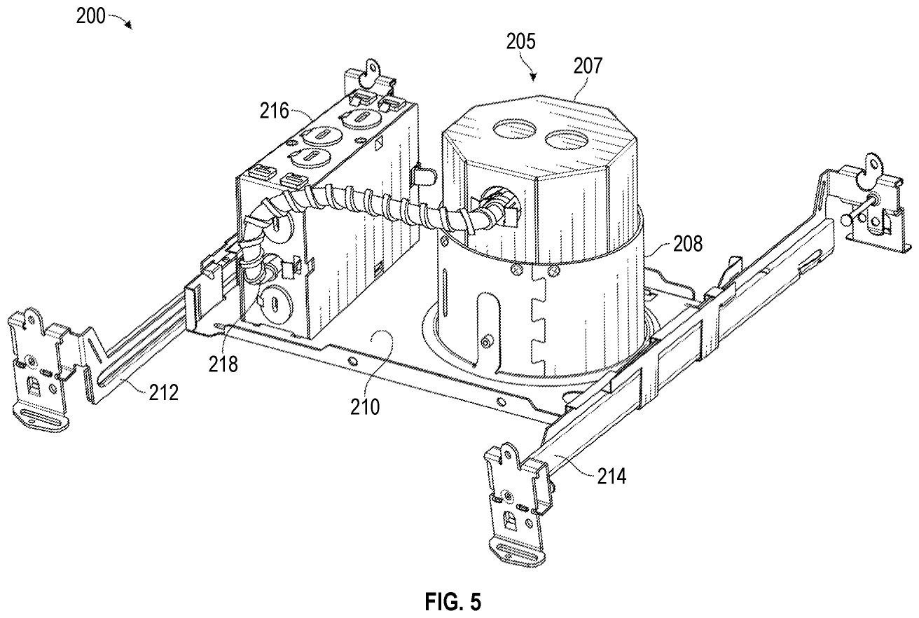

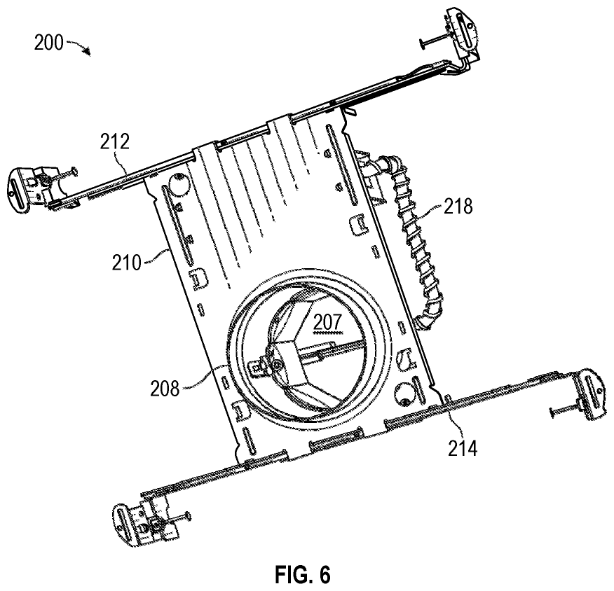

Referring to FIGS. 5 and 6, an example recessed lighting fixture 200 is shown. The example recessed lighting FIG. 200 may include a housing 205 mounted to a frame 210 and the frame 210 is attached to a pair of hanger bars 212 and 214. The pair of hanger bars 212 and 214 are typically fastened to joists or other supports in a ceiling so that the recessed lighting fixture can be installed in the ceiling and provide illumination for an area below the ceiling. The frame 210 can be made from plaster, metal or other materials known in the field. The frame 210 includes an aperture through which light is emitted from a light module placed within the housing 205. The light module can comprise one or more light emitting diodes or other light sources and the appropriate electrical leads for providing power to the light source. In the example recessed lighting fixture 200 shown in FIGS. 5 and 6, the light module has not been installed in the housing 205. Inside the housing 205, electrical wiring connections are visible in FIG. 2. The electrical wiring connections are connected to wiring that extends through conduit 218 to junction box 216 mounted on the frame 210.

The housing 205 can comprise a top 207 and a body 208. In the example of recessed lighting fixture 200, the top 207 comprises a top portion and a side wall portion having a generally cylindrical shape and the body 208 comprises a side wall having a generally cylindrical shape. The top portion can also comprise one or more wiring apertures through which wiring can pass for providing power to a light source within the housing 205. The top 207 and the body 208 can be joined with fasteners such as the rivets shown in FIG. 5.

The housing 205 also comprises an intumescent coating in order to provide fire resistance. The intumescent coating is typically a liquid applied to the housing 205 using a sprayer or other applicator as described above. The intumescent coating can be applied to both the inner and outer surfaces of the top 207 and the body 208 of the housing 205. Alternatively, the intumescent coating can be applied to only the inner surfaces of the top 207 and the body 208. As yet another alternative, the intumescent coating can be applied to only the outer surfaces of the top 207 and the body 208.

Using housing 205 comprising two components, top 207 and body 208, can provide advantages in applying the intumescent coating. Specifically, during the manufacturing process, it can be easier to apply a proper intumescent coating when the top 207 and body 208 are separated. As separate components, it is easier to ensure that all surfaces of the top 207 and body 208 receive a proper coating of the intumescent material. After the intumescent coating is applied, the top 207 and body 208 can be joined with fasteners to form the housing 205. In alternate embodiments, the housing 205 can comprise more than two components or the housing 205 may be a single component. While the top 207 and the body 208 have cylindrical shapes, in other embodiments, the housing 205 and/or its components can have other shapes.

In addition to coating the housing 205 with the intumescent material, other portions of the recessed lighting fixture 200 can receive the intumescent coating. For example, the intumescent coating can be applied to one or both of the broad top surface and broad bottom surface of the frame 210. As another example, a gasket is typically placed between the bottom portion of the housing 205 and the aperture in the frame 210. The intumescent material can be applied to the gasket or the gasket can be replaced with another gasket made of an intumescent material.

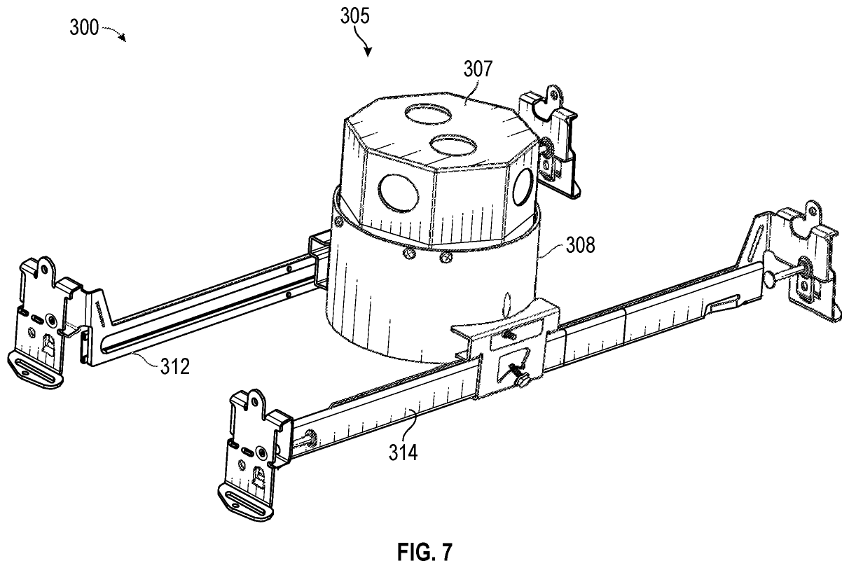

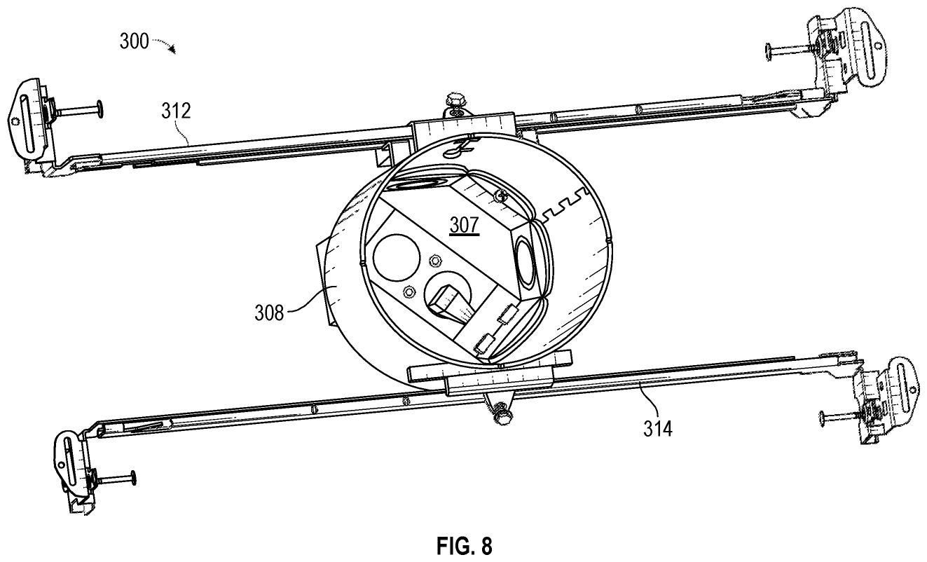

Referring now to FIGS. 7 and 8, an alternate example recessed lighting fixture 300 is illustrated. Recessed lighting fixture 300 is similar to recessed lighting fixture 200 of FIGS. 5 and 6, except that it does not include a frame with an external junction box mounted thereon. As a result, the pair of hanger bars 312 and 314 are coupled directly to housing 305. Similar to housing 205 of FIGS. 5 and 6, housing 305 comprises a top 307 and a body 308 that are joined with fasteners. The top 307 comprises a top portion and a side wall portion having a generally cylindrical shape and the body 308 comprises a side wall having a generally cylindrical shape. In other embodiments, the housing 305 can have other shapes and can comprise one or more components. During manufacture, the top 307 and the body 308 can be coated with an intumescent material such as the example coatings described above. Either the inner surfaces, the outer surfaces, or both the inner and outer surfaces of the top 307 and the body 308 can be coated with the intumescent material. After the intumescent coating is applied, the top 307 and the body 308 can be joined to form the housing 305.

Applying an intumescent coating to a recessed lighting fixture as described in the examples herein provides fire-resistance while permitting air to flow around the recessed lighting fixture for proper dissipation of heat generated during the operation of the light fixture. For example, when there is no fire and the recessed lighting fixture is operational, the heat dissipation from the housing 205, 305 is not obstructed by boxes or other intumescent materials because the intumescent coating is simply a thin layer of material applied to the recessed light fixture. However, when there is a threshold level of heat from a fire, the intumescent coating on the recessed lighting fixture will swell and inhibit the fire from spreading.

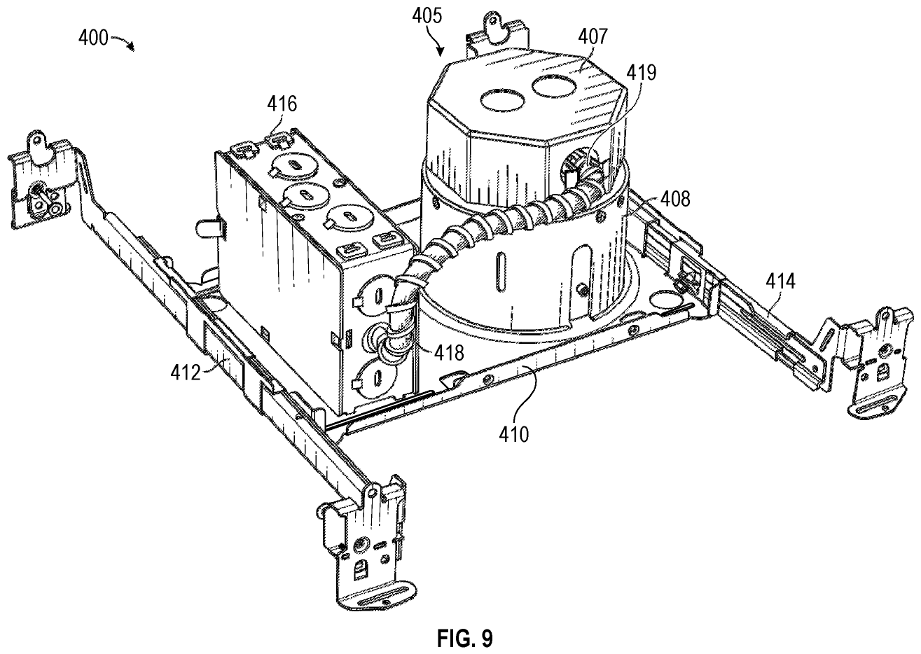

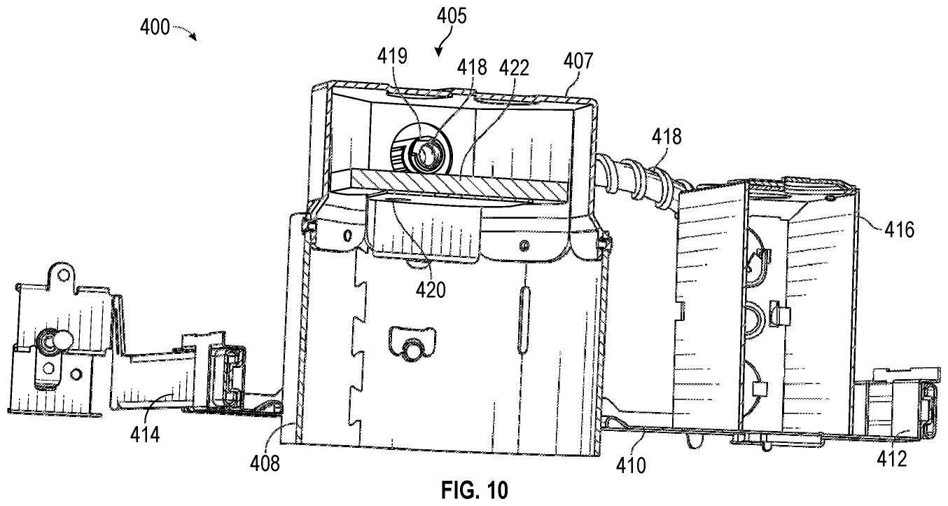

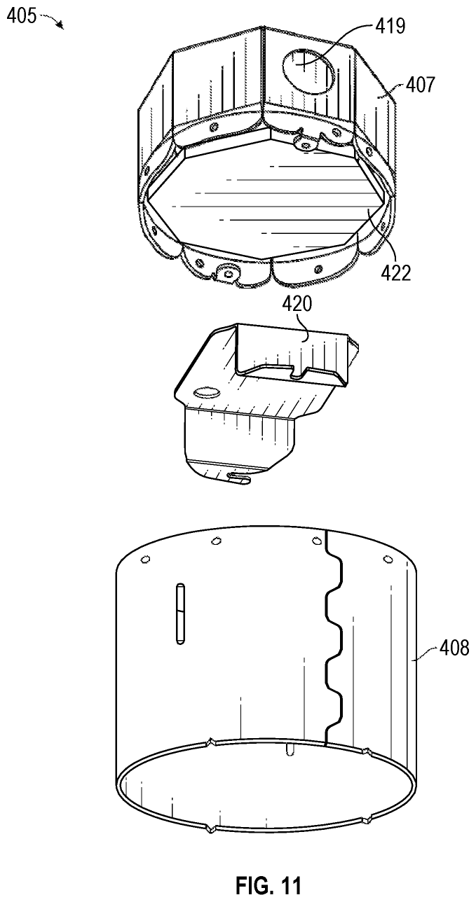

Yet another example embodiment is illustrated in FIGS. 9, 10, and 11. FIG. 9 illustrates a top perspective view of a recessed lighting fixture 400 in accordance with an example embodiment of the disclosure. FIG. 10 illustrates a cross-sectional view of the recessed lighting fixture 400 of FIG. 9 and FIG. 11 illustrates an exploded view of a housing 405 of the recessed lighting fixture 400 of FIG. 9.

The example recessed lighting FIG. 400 may include a housing 405 mounted to a frame 410 and the frame 410 can be attached to a pair of hanger bars 412 and 414. The pair of hanger bars 412 and 414 are typically fastened to joists or other supports in a ceiling so that the recessed lighting fixture 400 can be installed in the ceiling and provide illumination for an area below the ceiling. It should be understood that an alternate embodiment of recessed lighting fixture 400 can be implemented without a frame 410 where the hanger bars 412 and 414 can be attached directly to the housing 405 similar to the example arrangement shown previously in FIGS. 7 and 8.

The frame 410 can be made from plaster, metal or other materials known in the field. The frame 410 includes an aperture through which light is emitted from a light module placed within the housing 405. The light module can comprise one or more light emitting diodes or other light sources and the appropriate electrical leads for providing power to the light source. In the example recessed lighting fixture 400 shown in FIGS. 9-11, the light module has not been installed in the housing 405. Inside the housing 405, electrical wiring connections connect the leads from the light module to wiring that extends through wiring opening 419 in the housing 405 and through conduit 418 to junction box 416 mounted on the frame 410.

The housing 405 can comprise a top 407 and a body 408. In the example of recessed lighting fixture 400, the top 407 comprises a top portion and a side wall portion having a generally cylindrical shape and the body 408 comprises a side wall having a generally cylindrical shape. In the example shown in FIGS. 9-11, the wiring opening 419 is located in the side wall portion of the top 407 of the housing 405. However, in other embodiments, the wiring opening 419 can be located elsewhere, such as in the top portion of the top 407. The top 407 and the body 408 can be joined with fasteners such as rivets.

The housing 405 also comprises an intumescent material 422 disposed on a bracket 420 within the top 407. As can be seen in the cross-section illustrated in FIG. 10, the bracket 420 can extend across the inner cavity of the housing 405 and can be fastened at opposite sides to a top inner surface of the top 407. In alternate embodiments, the bracket 420 can have other configurations such as being attached to the inner surface of the body 408 or the bracket may not extend across the entire inner cavity of the housing 405.

In the example shown in FIGS. 10 and 11, the intumescent material 422 is in the form of a pad and is located on a top surface of the bracket 420 between the bracket 420 and the top inner surface. As such, the intumescent material 422 and the bracket 420 are located in the top 407 of the housing 405, but below the wiring opening 419. The intumescent material 422 and the bracket 420 can have openings that permit wiring to pass from the conduit 418 through the intumescent material 422, through the bracket 420, and to connect to the leads of the light module located below the bracket 420. In alternate embodiments, the intumescent material 422 can take other shapes and forms and may be attached to the bracket in other configurations. For example, the intumescent material 422 can be located on a bottom surface of the bracket 420.

In addition to the intumescent material 422 located within the housing 405, one or more portions of the recessed lighting fixture 400 can receive an intumescent coating in a manner similar to that described previously in connection with FIGS. 5-8. For example, the intumescent coating can be applied to the inner and/or outer surfaces of one or both of the body 408 and the top 407 of housing 405. The intumescent coating can also be applied to one or both of the broad top surface and broad bottom surface of the frame 410. As another example, an optional gasket placed between the bottom portion of the housing 405 and the aperture in the frame 410 can be coated with intumescent material or the gasket can be replaced with another gasket made of an intumescent material.

While the foregoing examples described in connection with FIGS. 5-11 relate to recessed lighting fixtures, it should be understood that the same concepts can be adapted to other types of outlet boxes. For example, housing 205 in FIGS. 5 and 6, housing 305 in FIGS. 7 and 8, and housing 405 in FIGS. 9-11 can be adapted to house other electrical components such as an electrical receptacle or a sensor while providing the similar fire resistant features described previously in connection with the recessed lighting fixtures. Accordingly, the embodiments described herein are not limited to recessed light fixtures.

Although the inventions are described with reference to example embodiments, it should be appreciated by those skilled in the art that various modifications are well within the scope of the invention. From the foregoing, it will be appreciated that an embodiment of the present invention overcomes the limitations of the prior art. Those skilled in the art will appreciate that the present invention is not limited to any specifically discussed application and that the embodiments described herein are illustrative and not restrictive. From the description of the example embodiments, equivalents of the elements shown therein will suggest themselves to those skilled in the art, and ways of constructing other embodiments of the present invention will suggest themselves to practitioners of the art. Therefore, the scope of the present invention is not limited herein.

What is claimed is:

1. A fire-resistance rated lighting fixture comprising:
a plaster frame comprising an aperture;
a recessed housing can positioned within the aperture such that a portion of the recessed housing extends above the plaster frame;
an outer housing comprising at least one side wall and a top wall arranged such that the at least one side wall and the top wall form a cavity,
wherein the outer housing is disposed on the plaster frame and over the recessed housing can and surrounding the recessed housing can; and
an intumescent material disposed in a space between the outer housing and the recessed housing can using one or more coupling members such that there is a gap extending between the intumescent material and the at least one side wall and between the intumescent material and the top wall of the outer housing.

2. The fire-resistance rated lighting fixture of claim 1, wherein the recessed housing can is configured to house a light source assembly, and wherein the recessed housing can comprises a bottom portion that defines an opening at the bottom edge of the recessed housing can and a top dome shaped portion coupled to the bottom portion.

3. The fire-resistance rated lighting fixture of claim 2, wherein the intumescent material is disposed in a space between the top wall of the outer housing and the top dome shaped portion of the recessed housing can.

4. The fire-resistance rated lighting fixture of claim 1, wherein the one or more coupling members include at least one of a bracket and a fastener.

5. The fire-resistance rated lighting fixture of claim 1, wherein a portion of each coupling member may be attached to a side wall of the outer housing using a fastener such that a remainder portion of the coupling member projects away from the side wall towards an opposite side of the fire-resistance rated lighting fixture, and wherein the intumescent material may be coupled to the remainder portion of the coupling member.

6. The fire-resistance rated lighting fixture of claim 1, wherein the intumescent material is in the shape of a rectangular prism.

7. A housing for a recessed electrical device, the housing comprising:
a body comprising at least one side wall, the at least one side wall comprising a side wall inner surface and a side wall outer surface;
a top attached to the at least one side wall, the top comprising a top inner surface and a top outer surface;
a wiring aperture in the housing for receiving wiring; and
an intumescent coating applied to the body and the top.

8. The housing of claim 7, wherein the housing is configured to attach to a frame.

9. The housing of claim 8, wherein the intumescent coating is applied to at least one of a top side of the frame and a bottom side of the frame.

10. The housing of claim 8, wherein the housing is configured to receive a gasket between the housing and the frame.

11. The housing of claim 10, wherein the gasket is an intumescent material.

12. The housing of claim 7, wherein the intumescent coating is applied to the body and the top before the body and the top are joined with fasteners.

13. A housing for a recessed electrical device, the housing comprising:
a body comprising at least one side wall, the side wall comprising a side wall inner surface and a side wall outer surface;
a top attached to the body, the top comprising a top inner surface and a top outer surface;
a bracket attached to at least one of the side wall inner surface and the top inner surface; and
an intumescent material attached to the bracket.

14. The housing of claim 13, wherein the bracket extends across a cavity defined by the housing.

15. The housing of claim 13, wherein the intumescent material is disposed between the bracket and the top inner surface.

16. The housing of claim 13, wherein the intumescent material is in a shape of a pad.

17. The housing of claim 13, wherein the intumescent material is attached to a top side of the bracket and a light module is disposed below the bracket.

18. The housing of claim 13, wherein the intumescent material and the bracket comprise openings through which wiring can pass.

19. The housing of claim 13, wherein the housing further comprises an intumescent coating applied to at least one of the body and the top.

20. The housing of claim 13, wherein the housing is mounted to a frame.
